(19) United States
(12) Patent Application Publication
(10) Pub. No.: US 2003/0088198 A1
(43) Pub. Date: May 8, 2003

(54) Myofascial stretching apparatus and method

(76) Inventor: Charles Richard Carpenter, East Brunswick, NJ (US)

Correspondence Address: Charles Carpenter, P.O. Box 117, Milltown, NJ, 08850, US

(21) Appl. No.: 10/035,718

(22) Filed: Nov. 7, 2001

(51) Int. Cl. A61H 15/00

(52) U.S. Cl. 601/121

(57) ABSTRACT

A torso and pelvic stretching apparatus comprising first and second or left and right fulcrums, a bolt, and a retaining device is disclosed. The retaining device holds the left and right fulcrums to the bolt and allows the left and right fulcrums to be removed from the bolt. The left and right fulcrums are adjustable with respect to the bolt so that the torso and pelvic stretching apparatus can be placed in a plurality of configurations. The retaining device may be comprised of a left spacer tube, a left elastic sleeve, a central tube, a right elastic sleeve, a right spacer tube, and left and right end pieces. The left end piece may be fixed to the bolt and the right end piece may be capable of being attached and detached from the bolt. The left and right elastic sleeves may be made of rubber and may be used to hold the left and right fulcrums, in one embodiment, to the bolt. The torso and pelvic stretching apparatus may be placed on a flat surface and moved to various positions with respect to an individual's back.

### FIELD OF THE INVENTION

This invention relates to improved methods and apparatus for increasing a person's thoracic and pelvic flexibility including the muscles, ligaments and related connective tissues of the spine, ribs and sternal region, and the sacro-illiac joints of the pelvis.

### BACKGROUND OF THE INVENTION

Stretching and/or elongating myofascia, i.e., the muscles and connective tissues, is believed to have a number of benefits. Besides improved flexibility, such stretching is believed to reduce the risk of muscle and spinal injury, for example strains, sprains and herniations, improve the removal of metabolic waste from the muscles and to improve the articulation of the relevant joints.

Numerous attempts have been made to achieve the benefits of stretching and/or elongating muscles. These include the methods and/or apparatus reported in U.S. Pat. Nos. 4,807,603; 4,785,800; 4,345,757; 4,207,878; 3,750,654; 3,705,579; 1,608,598; French Patent No. 1,127,127 and PCT application WO89/03667. Typically, these prior art devices and are not adjustable.

In an alternative approach, U.S. Pat. No. 5,1070,778 to Jamis reports an adjustable massage instrument in which the spacing between the peaks of the massage instrument can be increased or decreased. This device is used by rolling the body over it, although this patent reports that the rounded end elements may be placed on the floor to massage specific muscles, stress points and the feet.

Yet another alternative is described in Dutch Patent No. 7504998 where it is reported that the massage roller of the invention of that patent can be made in various sizes and shapes to suit different users. However, again, this device is used by rolling it along the part of the body to be massaged.

Despite the fact that these prior art devices and their reporting patents recommend that they be implemented by rolling the body over a massage instrument, doing so can be painful and potentially injurious to the person using such treatments. In addition, the above referenced patents restrict themselves to the stretching of the muscles, only. Thus, there is a need for a more effective means of stretching the thoracic and pelvic regions (including the sacrum and sacro-illiac joints) and the associated myofascia.

### SUMMARY OF THE INVENTION

The present invention, in various embodiments, provides a torso and pelvic stretching apparatus comprised of a pair or several pairs of cylindrical and/or beveled stretching devices of the same or slightly different diameters and widths, which in some cases may be called fulcrums, and which are adjustable along a bolt with a retaining device. In most embodiments, the torso and pelvic stretching apparatus is not used by rolling a person's body or back over the torso and pelvic stretching apparatus. Rather, the apparatus is used by allowing the person's weight to rest on the torso and pelvic stretching apparatus at a fixed position for a period of time, lifting off the torso and pelvic stretching apparatus, moving the apparatus to another fixed position, and then resting the person's weight on the apparatus for a period of time on a new location of the body. The fulcrums of the torso and pelvic stretching apparatus are adjustable with respect to the bolt so that the distance between a first peak on the left fulcrum and a second peak on the right fulcrum can varied to accommodate both the width of an person's torso and pelvis and the various myofascial structures of the person being addressed.

The torso and pelvic stretching apparatus may be comprised of a left fulcrum and a right fulcrum of varying dimensions. Each of the left and right fulcrums may be comprised of a rounded portion and a smaller diameter cylindrical or conical portion. The retaining device may be comprised of a left spacer tube, a left elastic sleeve, a central tube, a right elastic sleeve, a right spacer tube, and left and right end pieces. The left end piece may be fixed to the bolt and the right end piece may be capable of being attached or detached from the bolt. In one embodiment, the left and right elastic sleeves may be made of rubber and may be used to hold the left- and right-fulcrums in place along the bolt. The bolt may have a threaded circular end and one end piece may be attached and detached to and from the bolt by screwing or unscrewing the end piece onto the threaded circular end of the bolt.

The left spacer tube, the central tube, and the right spacer tube, may each have an inner diameter which is greater than the outer diameter of the bolt so that the bolt can be inserted through the left spacer tube, the central tube and the right spacer tube. The left and right elastic sleeves each may have an “at rest” or non-compressed opening having an inner diameter which is slightly greater than the outer diameter of the bolt.

The present invention, in one embodiment, includes a method comprising the steps of placing a torso and pelvic stretching apparatus on a flat surface; placing an individual's back against the torso and pelvic stretching apparatus so that a portion of the torso and pelvic stretching apparatus contacts a first area on the back of the individual; resting on that first area for a period of time to allow the fascia to lengthen; lifting up the individual's back so that torso and pelvic stretching apparatus no longer contacts the individual's back; moving the torso and pelvic stretching apparatus with respect to the individual's back; and placing the individual's back against the torso and pelvic stretching apparatus so that a portion of the torso and pelvic stretching apparatus contacts a second area on the back of the individual. The first area and the second area differ. The steps concerning placing an individual's back on the torso and pelvic stretching apparatus, resting on that area for a period of time, lifting off of the torso and pelvic stretching apparatus and moving the torso and pelvic stretching apparatus with respect to the individual's back, can be repeated for a plurality of areas of an individual's back and pelvis. The torso and pelvic stretching apparatus may be adjusted by changing the spacing of the fulcrums with respect to the bolt to accommodate the various widths of the vertebrae, other bony structures or other related soft tissues.

The present invention increases flexibility and range of motion of the joint spaces and articulations of the vertebrae, the ribs, and the pelvis, as well as the intra-costal spaces of both the anterior and posterior regions of the rib cage and the costal cartilage. The posterior spinal processes of the person can be placed between left and right fulcrums. By resting on the apparatus in this manner, the left and right fulcrums focus the forces upon the soft tissues between the boney structures causing the myofascial structures of that and related areas to lengthen.

The present invention in its various embodiments provides a progressive training apparatus that can be modified to accommodate various spinal conditions and configurations, e.g., scoliosis, an individual's degree of flexibility. In one embodiment, a pair or pairs of left and right fulcrums are provided in increasing diameters. The diameters can be mixed and combined when needed to achieve the desired results. A progressive course of training may be comprised of sequentially moving the apparatus along the individual's spine from caudal to cranial, and increasing the diameter of the left and right fulcrums over time as the body adapts.

### BRIEF DESCRIPTION OF THE DRAWINGS

FIG. 1 shows a front view of an apparatus comprising left and right fulcrums, with the left and right fulcrums placed in a first configuration;

FIG. 2 shows a front view of the apparatus of FIG. 1 with a right end piece separated from the rest of the apparatus;

FIG. 3 shows a front view of the apparatus of FIG. 1 with a right spacer tube and the right end piece separated from the rest of the apparatus;

FIG. 4 shows a front view of the apparatus of FIG. 1 taken apart;.

FIG. 5 shows a front view of the apparatus of FIG. 1 with the left and right fulcrums placed in a second configuration;

FIG. 6 shows a front view of the apparatus of FIG. 1 with the left and right fulcrums placed in a third configuration;

FIG. 7 shows a front view of the apparatus of FIG. 1 with the left and right fulcrums placed in a fourth configuration;

FIG. 8A shows a right side view of a left end piece that is part of the apparatus shown in FIG. 1;

FIG. 8B shows a left side view of the left end piece;

FIG. 9A shows a right side view of a right end piece which is part of the apparatus of FIG. 1;

FIG. 9B shows a left side view of the right end piece;

FIG. 10 shows left side view of a left fulcrum shown in FIG. 1;

FIG. 11 shows a right side view of the left fulcrum shown in FIG. 1;

FIG. 12A shows a side view of a left spacer tube that is part of the apparatus of FIG. 1;

FIG. 12B shows a side view of a left elastic sleeve that is part of the apparatus of FIG. 1; and

FIG. 12C shows a right side view of a central tube that is part of the apparatus of FIG. 1.

### DETAILED DESCRIPTION OF THE DRAWINGS

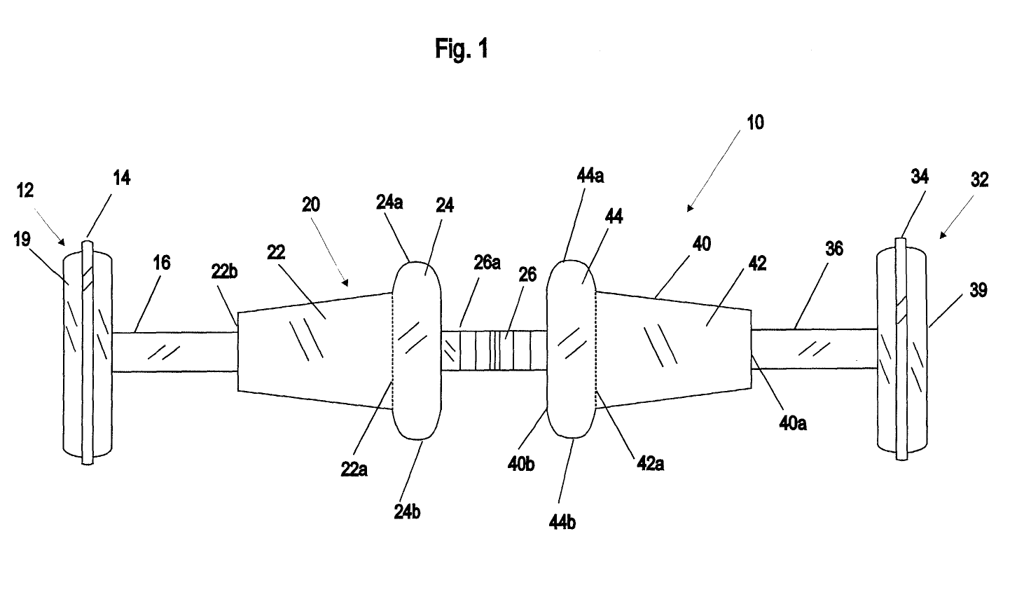

FIG. 1 shows a front view of an apparatus 10 in which the apparatus 10 is assembled in a first configuration. The apparatus 10 is comprised of a left end piece 12 and a right end piece 32, a left spacer tube 16 and a right spacer tube 36, a left fulcrum 20 and a right fulcrum 40, and a central tube 26. The left and right end pieces 12 and 32 are rounded but could be replaced by differently shaped pieces, for example, square blocks.

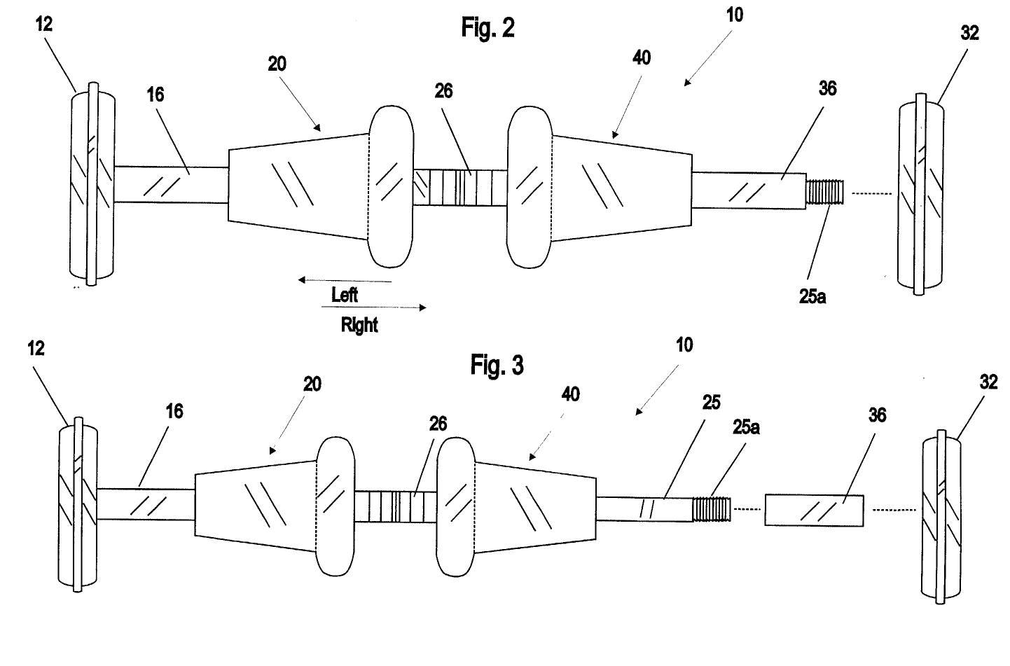

FIGS. 2 and 3 show front views of the apparatus 10 partially disassembled. These figures will be described following the detailed description of FIG. 12C.

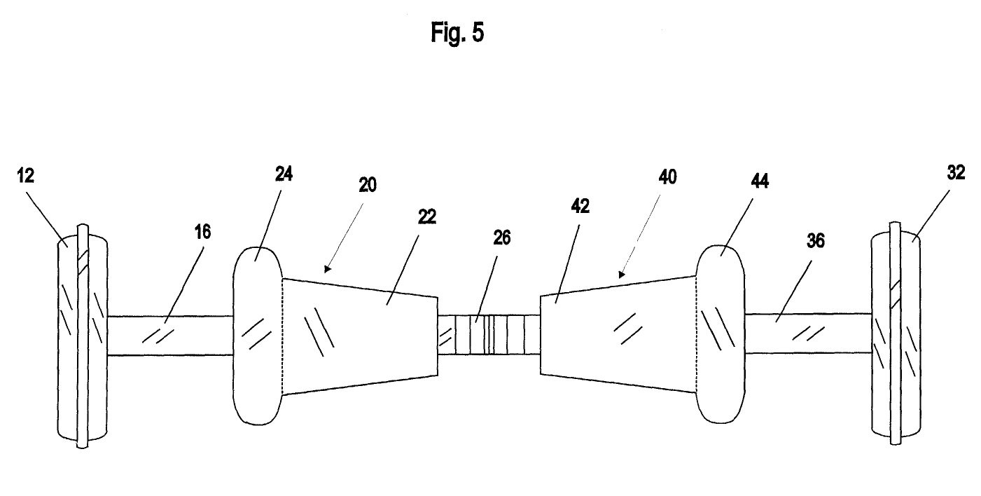

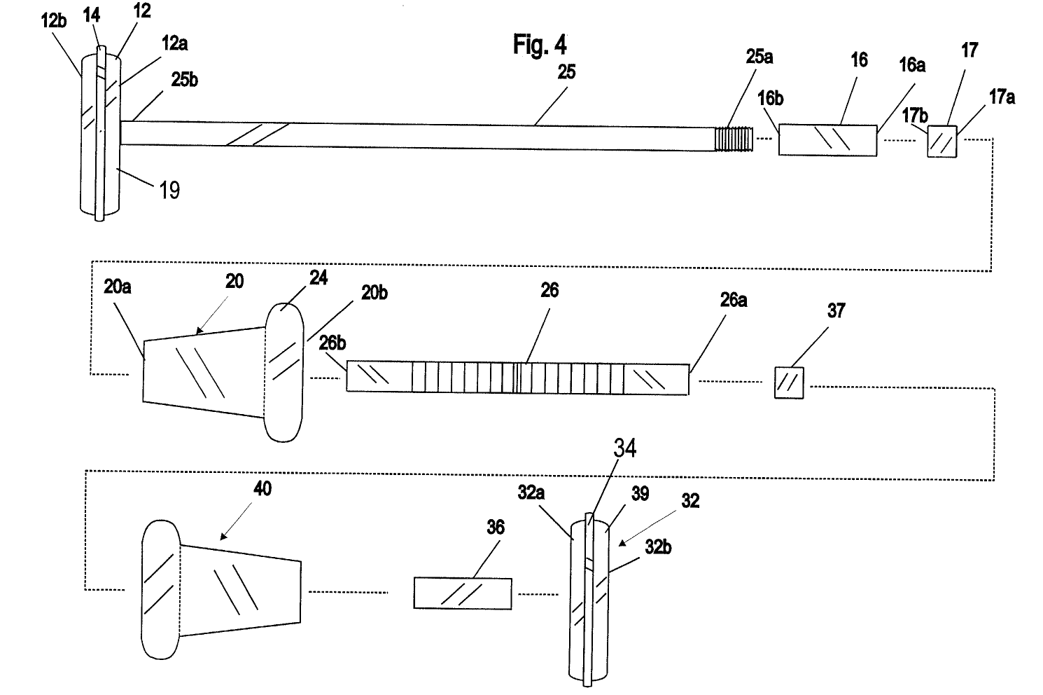

FIG. 4 shows a front view of the apparatus 10 taken apart. The apparatus 10 is also comprised of a central bolt 25, a left end piece 12, a left o-ring 14, a left spacer tube, 16, a left elastic sleeve 17, a left fulcrum 20, a central tube, a right elastic sleeve 37, a right fulcrum 40, a right spacer tube 36, a right o-ring 34, a right end piece 32, and a hex nut 33. The left and right spacer tubes 16 and 36, the left and right elastic sleeves 17 and 37, the central tube 26, and the left and right end pieces 12 and 32 together can be thought of as making up a retaining device.

The central bolt 25 has two ends, 25a and 25b, shown in FIG. 4. One end 25b may be threaded to be screwed into a hex nut 33.

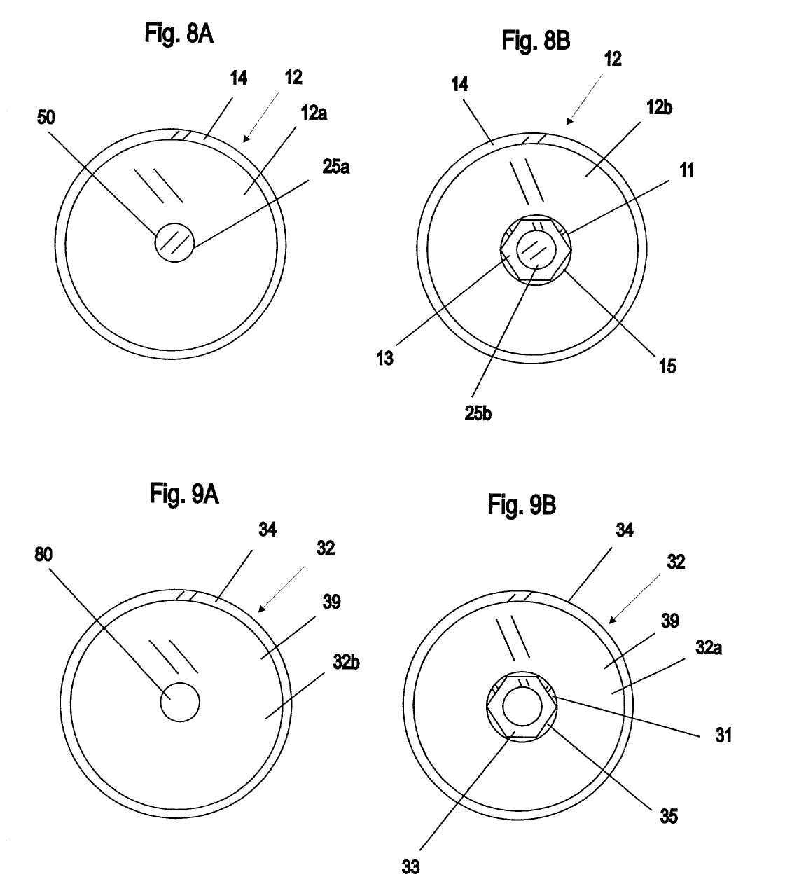

Referring again to FIGS. 1 and 4, the left end assembly 12 is comprised of round end piece 19, and a resilient rim 14. The resilient rim 14 may be made of rubber or a suitable material to prevent scratching a hard floor. The left end piece 19 has a right shoulder 19a and a left shoulder 19b, shown in FIG. 4. The left end piece 19 has a small circular opening 50 on its right side, the location of which is shown in FIG. 8A and a larger opening 15 shown on its left side shown in FIG. 8B. Opening 15 may be sized and shaped to accommodate the left end of the central bolt 25 so that it remains fixed in relationship to the end piece 19 when rotated.

The left end piece 19 of the apparatus 10 is, in one embodiment, fixed to the central bolt 25 at the end 25b. The left end 25b or head of bolt 25 may be inserted into the opening 15 in FIG. 8B and may be secured using an adhesive to the left end piece so that the central bolt 25 cannot rotate with respect to the left end piece 19. In one embodiment, the head 25b of the central bolt 25 shown in FIG. 4, cannot be removed or rotated with respect to the left end assembly 12, but rather is permanently fixed to the left end piece 19.

FIG. 9A shows a left side view of the right end assembly 32. FIG. 9B shows a right side view of the right end assembly 32. The right end assembly 32 includes a round end piece 39 and a resilient rim 34. The right end piece 39 also includes a hole 80 on the left side of the right end piece 39 as shown in FIG. 9A. The right end piece 39 also includes a hole 35 on the right side of the right end piece 39 as shown in FIG. 9B. The right end assembly 32 includes a hex nut 33 that is fixed, such as by adhesive 31, to the round end piece 39 of the right end assembly 32.

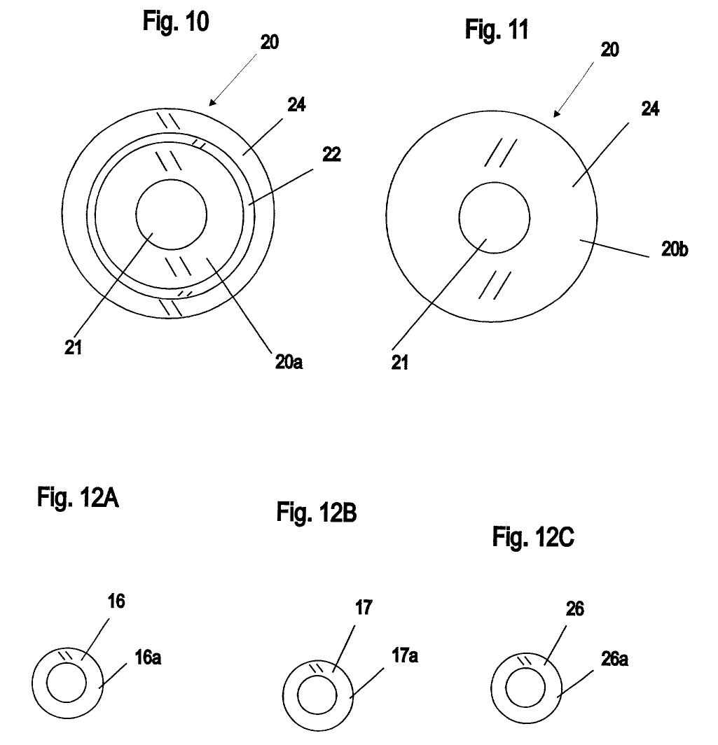

FIGS. 10 and 11 show left and right side views, respectively, of the left fulcrum 20. The left fulcrum 20 has a cylindrical opening 21 that runs through its entire length, a surface 20a, a cylindrical and/or conical portion 22, and a peak 24 as shown in FIG. 10. The left fulcrum 20 also includes a surface 20b shown in FIG. 11. The right fulcrum 40 is identical to the left fulcrum 20.

FIG. 12A shows a side view of a spacer tube 16. The left and right spacer tubes 16 and 36 are identical. The left spacer tube 16 includes a surface at end 16a. The left side view of the left spacer tube 16 would be identical to FIG. 12A, with the exception that the surface at end 16a would be replaced by the surface at end 16b identified in FIG. 4. The left spacer tube 16 may be identical to the right spacer tube 36. The left spacer tubes 16 and 36 have an inner diameter of D6, which may be ½ of an inch and an outer diameter D3 which may be ⅝ of an inch. s

FIG. 12B shows a right side view of a left elastic sleeve 17. The left elastic tube 17 includes a surface at end 17a. The left side view of the left elastic sleeve 17 would be identical to FIG. 12B, with the exception that the surface at end 17a would be replaced by the surface at end 17b identified in FIG. 4. The left elastic sleeve 17 may be identical to the right elastic sleeve 37. The left elastic sleeve may have an inner diameter of D7 and an outer diameter of D4 which may be equal to the inner diameter and outer diameter D6 and D3, respectively, of left spacer tube 16.

FIG. 12C shows a right side view of a central tube 26. The central tube 26 includes a surface at end 26a. The left side view of the central tube 26 would be identical to FIG. 12C, with the exception that the surface at end 26a would be replaced by the surface at end 26b identified in FIG. 4. The central tube 26 may have an inner diameter D8 and an outer diameter D5 which may be equal to the inner diameter and the outer diameter D6 and D3, respectively, of left spacer tube 16. The wall thickness of the left and right spacer tubes 16 and 36 are identical to the wall thickness of the central tube, which is nearly identical to the wall thickness of the elastic sleeves 17 and 37.

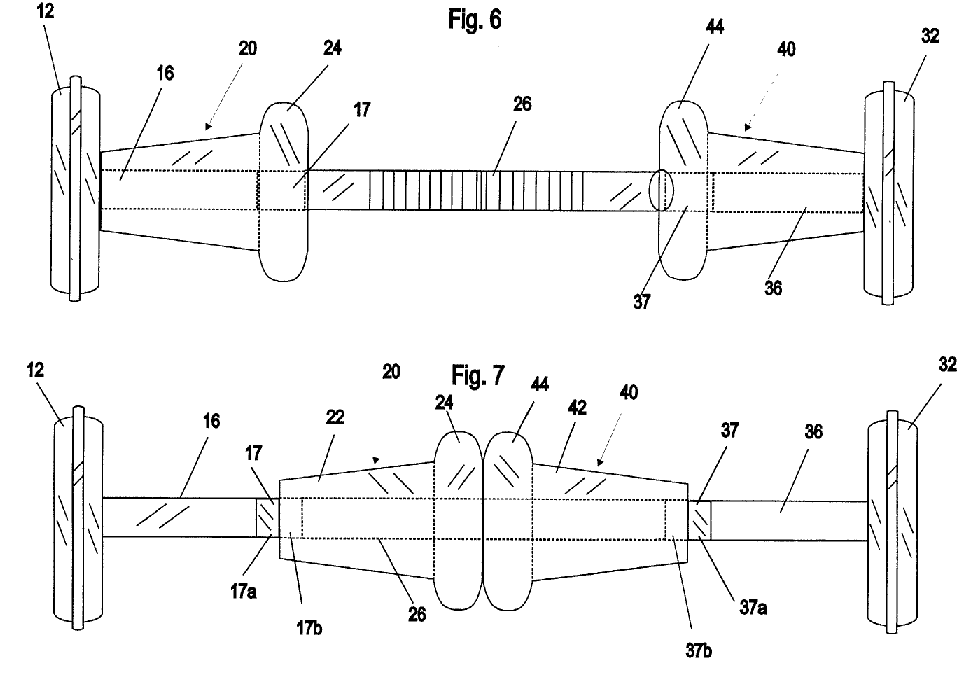

FIG. 1 shows a first assembled configuration of the apparatus 10. The apparatus 10 can be changed to a different configuration by first unscrewing the right end assembly 32 from the right end 25a of the bolt 25, as shown by FIG. 2. When the right end assembly 32 has been loosened from the threaded end 25a, the fulcrums 20 and 40 will be able to slide horizontally to either the left or the right. More specifically, the left fulcrum 20 will be able to slide to the left over the left spacer tube 16 until the left fulcrum 20 comes in contact with the left end piece 12 as shown in FIG. 6. The right fulcrum 40 will be able to slide to the right over the right spacer tube 36 until the right fulcrum 40 comes in contact with the right end piece 32 or until the right fulcrum 40 has been removed from the bolt 25 as shown in FIG. 4. The left fulcrum 20 also can slide to the right until the left fulcrum 20 comes in contact with the right fulcrum 40 as shown in FIG. 7, or until the left fulcrum 20 has been removed from the bolt 25 as shown in FIG. 4 [assuming right fulcrum 40 has already been removed off of the bolt 25]. The right fulcrum 40 can slide to the left, until the right fulcrum 40 contacts the left fulcrum 20, as in FIG. 7. The configuration of FIG. 6 could also be modified to slide the right fulcrum 40 to the right until the right fulcrum 40 is contacting the left fulcrum 20.

FIGS. 1, 5, 6, and 7 show four possible example configurations in which the fulcrums 20 and 40 may be placed to comprise an assembled apparatus 10. There are a plurality of further configurations which may be obtained simply by sliding the fulcrums 20 and 40 horizontally along the bolt 25 and/or by flipping, or rotating by 180 degrees the fulcrums 20 and 40 as shown in FIGS. 1 and 5. In FIG. 1 the peaks 24 and 44 of the fulcrums 20 and 40 respectively, face each other, while in FIG. 5, the peaks 24 and 44 face away from each other.

The fulcrums 20 and 40 each have a cylindrical hole, like hole 21, of fulcrum 20, shown in FIGS. 10 and 11, with a diameter slightly larger than the outer diameter of the left and right spacer tubes 16 and 36, central tube 26, and the left and right elastic sleeves 17 and 37 so that they may easily slide over the length of the apparatus. Each fulcrum may also have a total length of three and seven-eighths (3 and ⅞) inches, and may have a peak 24 or 44 having a width of ⅞ of an inch. The diameters of the rounded portions 24 and 44 may each be three inches, which may be slightly less than the diameter of the left and right end pieces 12 and 32. The cylindrical hole 21 has a large enough diameter so that the fulcrum 20 can slide over the left spacer tube 16 [whose location is shown in dashed lines in FIG. 6], the left elastic sleeve 17 [whose location is shown in dashed lines in FIG. 6], the central tube 26, the right elastic sleeve 37 [whose location is shown in dashed lines in FIG. 6], the right spacer tube 36 [whose location is shown in dashed lines in FIG. 6], and generally over the bolt 25.

The outer diameter of the left spacer tube 16, D3, shown in FIG. 12A, the outer diameter D4 of the left elastic sleeve 17 shown in FIG. 12B, and the outer diameter D5 of the central tube 26, shown in FIG. 12C, can be the same [at least when elastic sleeve 17 is at rest, i.e., not compressed] and should be slightly less than the diameter of the cylindrical hole 21, so that the left spacer tube 16, the left elastic sleeve 17, and the central tube 26 [as well as the right elastic sleeve 37 and the right spacer tube 36] can pass through cylindrical hole 21. The inner diameters D6, D7, and D8 of the left spacer tube 16, shown in FIG. 12A; the left elastic sleeve 17, shown in FIG. 12B; and the central tube 26, shown in FIG. 12C; respectively, should be the same and should be slightly greater than the outer diameter of the bolt 25, so that the bolt 25 can pass through openings 16c, 17c, and 26c and similar openings in the right elastic sleeve 37, and the right spacer tube 36.

When the right end piece 32 is tightened on bolt 25, for example as in FIGS. 1, 5, 6, and 7, the left side of the right end assembly 32 presses against the right spacer tube 36, which in turn presses against the elastic sleeve 37 as shown in FIG. 6 and FIG. 7. The elastic sleeve 37 also presses against the central tube 26 which presses against the left elastic sleeve 17 which presses against the left spacer tube 16 which presses against the right side of the left end piece 12. In this manner, the elastic sleeves 17 and 37 are compressed or squeezed horizontally, causing the outer diameter D4 of the elastic sleeves 17 and 37 to enlarge. The elastic sleeve 17 expands into the opening 21 of fulcrum 20. The elastic sleeve 37 similarly expands in a similar opening of fulcrum 40. This expansion makes it difficult, if not impossible, to slide the fulcrums 20 and 40 to the left or right. Thus, the fulcrums 20 and 40 remain fixed so they cannot slide when the right end piece 32 has been tightened. It is important that, whatever the configuration, the fulcrums 20 and 40 are placed so that some portion of the elastic sleeves 17 and 37 remain in the cylindrical opening of the fulcrums 20 and 40, respectively, such as cylindrical opening 21 of the left fulcrum 20. For example in FIG. 7, a portion 17a of the elastic sleeve 17 is shown outside of the cylindrical opening 21 of left fulcrum 20 and a portion 17b is shown inside the circular opening 21 of the left fulcrum 20. Similarly a portion 37a of the elastic sleeve 37 is shown outside of the cylindrical opening 31 of right fulcrum 20 and a portion 37b is shown inside the cylindrical opening 31 of right fulcrum 20. When the right end piece 32 is tightened the portions 17b and 37b hold the fulcrums 20 and 40 fixed in place.

FIG. 4 shows a front view of the apparatus 10 in a disassembled state. The left end piece 12 is shown fixed to the bolt 25 at the head. The left spacer tube may be placed over the bolt 25 at end 25a. The left elastic sleeve 17 may be placed over the bolt 25. The fulcrum 20 may be placed over the bolt 25. The central tube 26 may be placed over the bolt 25. The right elastic sleeve 37, the right fulcrum 40 and the right spacer tube 36 are similar to their left counterparts and may be placed over the bolt 25 in a similar manner. The right end piece 32 has an internally threaded opening 33, shown in FIG. 9B, which can be screwed onto the threaded right end of the bolt 25.

In operation, in accordance with a method for using the apparatus 10, an individual would fix the fulcrums 20 and 40 in a configuration appropriate to dimensions of the area of the individual's body being addressed, for example, in a configuration such as in FIGS. 1, 5, 6, or 7, or some other configuration. The individual would then place the apparatus 10 on a flat surface such as a floor. The individual would lie down on the apparatus 10 so that the person's back would come into contact with peaks 24 and 44 of fulcrums 20 and 40, respectively. Peaks 24 and 44 would be placed so that they press between two vertebrae of a person's spine through the clothing and skin. In one embodiment of the present invention, the peaks 24 and 44 are first placed so that they are in the lumbar or lower back region between the first two vertebrae. The individual would rest on peaks 24 and 44 and on the apparatus 10 until the myofascial structures within the area of contact with peaks 24 and 44 lengthen. The individual may wait until the area of his or her back being stretched is lengthened. Then the individual lifts that portion of his or her body up so that his or her back is no longer contacting the apparatus 10. The apparatus 10 is then moved up approximately one to two vertebrae and the person's body weight is again lowered onto the apparatus 10, so that peaks 24 and 44 are again contacting the back. The second area is then slowly stretched. In one embodiment of a method in accordance with the present invention this process is continued for different areas of the spine, for the entire spine, up to the base of the skull.

The apparatus 10 and method in accordance with the present invention improves the flexibility of the tissues as well as improves the general health and well being of the tissues by improving circulation in the affected tissues. While the training apparatus 10 and method of the present invention has its greatest effect on the area against which it is placed, such as the posterior surface of the body; it is designed to also affect the anterior portions of the rib cage including the sternal regions. This anterior stretch can be increased by raising the individual's arms over his or her head while lying on the training apparatus 10.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a first fulcrum;
a bolt;
a retaining device;
wherein the retaining device holds the first fulcrum to the bolt and allows the first fulcrum to be removed from the bolt;
and wherein the first fulcrum is adjustable with respect to the bolt so that the first fulcrum can be placed in a plurality of configurations.

2. The apparatus of claim 1 further comprised of
a second fulcrum.

3. The apparatus of claim 1 wherein
the retaining device is comprised of a left end piece which is fixed to the bolt and a right end piece which can be attached and detached from the bolt.

4. The device of claim 3 wherein
the bolt has a threaded circular end and
wherein the right end piece can be attached to the bolt by screwing the right end piece onto the threaded circular end of the bolt;
and the right end piece can be detached from the rod by unscrewing the right end piece off the threaded circular end of the bolt.

5. The apparatus of claim 1 wherein
the retaining device is comprised of a left elastic sleeve and a right elastic sleeve;
and wherein the left elastic sleeve can be used to hold the first fulcrum to the bolt and the right elastic sleeve can be used to hold the second fulcrum to the bolt.

6. The device of claim 5 wherein
the retaining device is comprised of left spacer tube, a central tube, a right spacer tube

7. The device of claim 6 wherein
the bolt is a cylinder having an outer diameter;
the left spacer tube, the central tube, and the right spacer tube each have an opening having an inner diameter which is greater than the outer diameter of the bolt so that the bolt can be inserted through each of the openings of the left spacer tube, the right spacer tube, and the central tube; and
the left and right elastic sleeves each have an opening having an inner diameter which, when the left and right elastic sleeves are at rest and not compressed, is slightly greater than the outer diameter of the bolt;
so that the bolt can be inserted through the left spacer tube, the left elastic sleeve, the central tube, the right elastic sleeve, and the right spacer tube.

8. The apparatus of claim 2 wherein
The first and second fulcrums have an inner diameter that is slightly larger than the outer diameter of the left, central and right spacer tubes and the left and right elastic sleeves so that the first and second fulcrums may be inserted over the spacer tubes and the elastic sleeves when the elastic sleeves are not compressed.

9. The device of claim 3 wherein
The bolt, the left, central, and right spacer tubes, the left and right elastic sleeves, and the first and second fulcrums are fully assembled and the right end piece is threaded and tightened onto the bolt against the right spacer tube so as to compress the elastic sleeves, the elastic sleeves expand and press against the inner diameter of the first and second fulcrums and the outer diameter of the bolt simultaneously.

10. A method comprising the steps of:
placing an a torso and pelvic stretching apparatus on a flat surface;
placing an individual's back against the torso and pelvic stretching apparatus so that a portion of the torso and pelvic stretching apparatus contacts a first area on the back of the individual;
resting the weight of the body on the torso and pelvic stretching apparatus for a period of time to allow the fascia to lengthen
lifting up the individual's back so that the torso and pelvic stretching apparatus no longer contacts the individual's back;
moving the torso and pelvic stretching apparatus with respect to the individual's back;
placing the individual's back against the torso and pelvic stretching apparatus so that a portion of the torso and pelvic stretching apparatus contacts a second area on the back of the individual; and
wherein the first area and the second area differ.

11. The method of claim 10 further comprised of
the torso and pelvic stretching apparatus is comprised of left fulcrum and a right fulcrum.

12. The method of claim 11 wherein
the torso and pelvic stretching apparatus is comprised of a bolt and a retaining device
wherein the left and right fulcrums are attached to the bolt by the retaining device.

13. The method of claim 12 wherein
the retaining device includes left and right end pieces which hold the left and right fulcrums onto the bolt.

14. The method of claim 13 further comprising the step of
adjusting the left and right fulcrums with respect to the bolt.

15. The method of claim 10 wherein
the first area is between first and second vertebra of the individual's back;
and the second area is between third and fourth vertebra of the individual's back.

16. The method of claim 10 further comprising the steps of
repeating for a plurality of further areas the steps of:
placing an individual's back against the torso and pelvic stretching apparatus so that a portion of the torso and pelvic stretching apparatus contacts a further area on the back of the individual;
resting the weight of the body on the torso and pelvic stretching apparatus for a period of time to allow the fascia to lengthen
lifting up the individual's back so that the torso and pelvic stretching apparatus no longer contacts the individual's back;
moving the torso and pelvic stretching apparatus with respect to the individual's back;
in a manner so that the torso and pelvic stretching apparatus is moving from a first area in the lower lumbar region of the individual's back to a neck region of the individual;
and stopping the process after the torso and pelvic stretching apparatus has contacted an area in the neck region of the individual.

17. The method of claim 16 further wherein
the torso and pelvic stretching apparatus is comprised of left fulcrum and a right fulcrum.
further comprising the steps of adjusting the torso and pelvic stretching apparatus with respect to the bolt.
